(19) United States
(12) Patent Application Publication
(10) Pub. No.: US 2015/0167832 A1
(43) Pub. Date: Jun. 18, 2015

(54) HYDRAULIC SYSTEM IN PARTICULAR FOR ACTUATION OF A TRANSMISSION SYSTEM

(71) Applicant: DTI Group, B.V., Eindhoven (NL)

(72) Inventors: Roell Marie Van Druten, Eindhoven (NL); Alexander Franciscus Anita Serrarens, Waalre (NL); Bas Gerard Vroemen, Eindhoven (NL)

(21) Appl. No.: 14/403,412

(22) PCT Filed: May 23, 2013
(86) PCT No.: PCT/NL2013/050375

§ 371 Date: Nov. 24, 2014

(30) Foreign Application Priority Data
May 23, 2012 (NL) 2008866

(51) Int. Cl. F16H 61/00; F16H 63/06; F16H 63/34

(52) U.S. Cl. CPC F16H 61/0025; F16H 63/3483; F16H 63/065; F16H 2061/0034

(57) ABSTRACT

A hydraulic system 71, more particularly for the actuation of a transmission system, comprises
an oil pump 67, which is driven by one of the shafts of the transmission system or a drive source, which pump has an input and an output, which input is connected to the oil tank 75 and which output is connected to a main line 73,
a switchable valve 91, which is located between the output 69 of the oil pump 67 and the oil tank 75,
a restriction 93, which is located between the switchable valve 91 and the oil tank 75, and
a further valve 95, which is located between the output 69 of the oil pump 67 and the main line 73.

The switchable valve 91 is operated such that the line pressure produced by the oil pump can be made lower or higher than the pressure in the main line 73.

### FIELD OF THE INVENTION

The invention relates to a hydraulic system, more particularly for the actuation of a transmission system, comprising:
an oil pump, which is driven by one of the shafts of the transmission system or a drive source, which pump has an input and an output, which input is connected to the oil tank and which output is connected to a main line,
a switchable valve, which is located between the output of the oil pump and the oil tank,
a restriction, which is located between the switchable valve and the oil tank, and
a further valve, which is located between the output of the oil pump and the main line.

### STATE OF THE ART

A hydraulic system of this type for a driving mechanism is generally known. When applying the known hydraulic systems to a driving mechanism in a vehicle which is equipped with a drive away module and a transmission, relatively much energy is lost on actuation and cooling of the drive away module when the vehicle drives off and/or gears are changed and in the event the transmission system is arranged as a CVT (continuous variable transmission) variator, also in the operation of this.

### SUMMARY OF THE INVENTION

It is an object of the invention to provide a hydraulic system of the type defined in the opening paragraph for a driving mechanism, where less energy is required for the actuation and cooling of the drive away module and possibly the operation of the variator. For this purpose the hydraulic system according to the invention is characterized in that the switchable valve is operated such that the line pressure produced by the oil pump can be made lower or higher than the pressure in the main line. The line pressure produced by the oil pump can thus (temporarily) be made lower (or higher) than the pressure of the main line, leading to less energy being lost. The oil under reduced pressure can then be used for lubrication of transmission parts. The switchable valve can then be driven such that the line pressure produced by the oil pump is intermittently made lower or higher (temporarily, of the order of seconds).

The switchable valve is preferably arranged as an on/off valve, the restriction is preferably arranged as a valve or as an pressure relief valve, and the further valve is preferably arranged as a non-return valve.

An embodiment of the hydraulic system according to the invention is characterized in that the hydraulic system further includes an accumulator which is connected to the main line, where the switchable valve is operated such that the pressure in the accumulator is maintained between a minimum and a maximum value.

The hydraulic system preferably further includes a further switchable valve which is located between the oil pump and the accumulator, or which is located between the oil pump and the main line, where the accumulator is located between the further switchable valve and the output of the oil pump, or which is located between the accumulator and the output of the switchable valve or the input of the restriction. This further switchable valve is preferably arranged as an on/off valve.

A further embodiment of the hydraulic system according to the invention is characterized in that the hydraulic system further includes an additional valve which is located between the accumulator and the main line. This additional valve is preferably arranged as a non-return valve.

A still further embodiment of the hydraulic system according to the invention is characterized in that the hydraulic system further includes a further oil pump which is driven by one of the shafts of the transmission system or a drive source and has an input and an output, which input is connected to the oil tank and which output is connected to the output of the further valve.

The delivery of this further oil pump is preferably less than one third of the delivery of the oil pump. The further oil pump and the oil pump are preferably driven by the same shaft.

This further oil pump and the oil pump are furthermore preferably combined to a single double acting oil pump having one input and two outputs. This double acting oil pump preferably comprisis two delivery chambers which are unequal to each other. A double acting oil pump is understood to be an oil pump of which a delivery chamber is located on either one of the two sides of the impeller body (for example a piston).

Yet a further embodiment of the hydraulic system according to the invention is characterized in that the hydraulic system further includes a further additional valve, which is located between the output of the further oil pump and the oil tank, or which is located between the output of the further oil pump and the output of the switchable valve or the input of the restriction. The latter configuration is advantageous in that if the switchable valve is closed for the purpose of extra flow in the high pressure circuit, the oil blown off by the further additional valve becomes available for the low pressure circuit (cooling, lubrication) in lieu of being discharged completely to the tank as a result of which the low pressure circuit in the worst case scenario does not receive any oil any more. This further additional valve is preferably arranged as a pressure relief pressure valve or an on/off valve.

Yet again a further embodiment of the hydraulic system according to the invention is characterized in that the hydraulic system further includes an auxiliary valve which is located next to the switchable valve between the output of the oil pump and the pressure relief valve or which is integrated with the switchable valve. This auxiliary valve is preferably arranged as a non-return valve.

The hydraulic system is pre-eminently suitable for use in a driving mechanism for a vehicle, comprising:
a drive source,
a drive away module which has an input which is connected to the drive source and an output, which module comprises a brake, as well as a planetary gear set having at least three rotational members, of which a first rotational member is connected to the input, a second rotational member is connected to the output and a third rotational member is connected to the brake,
a transmission having a transmission housing, which transmission is provided with an input shaft which is connected to the output of the drive away module, and an output shaft, as well as at least one switchable or variable transmission, and
an final drive which has an input, which is connected to the output shaft of the transmission, and an output.

In this configuration the brake is preferably arranged as a dry plate friction brake. This requires no cooling (which is usually oil cooling) for driving off from a stationary position. By arranging the drive away module and final drive such that they have large transmission ratios, the transmission may be arranged as a relatively small CVT variator which has greater efficiency than a large CVT variator and, besides, requires less oil flow for its operation. Since no cooling is needed for driving off and less oil flow is needed for operating the variator, in addition a relatively small oil pump can suffice.

The brake is preferably located in a dry space so that fewer fluid seals are needed than if the brake were accommodated in a wet space of for example the transmission. This dry space may be for example a space between the transmission housing and a housing part fitted to it.

The brake preferably comprises two brake plates as well as a brake disc which is located between the brake plates and is covered with friction material, while the brake disc is connected to the third rotational member of the planetary gear set and the brake plates are connected to the transmission housing. As a result of this the heat developed during the braking action can be dissipated well to the transmission housing.

The driving mechanism preferably includes cooling means which actively cool down the brake plates with cooling liquid from the drive source or with oil from the transmission.

The planetary gear set may also be located in the dry space so that no sealing need be present between the brake and the planetary gear set. In that case the planetary gear set is preferably duly greased.

The driving mechanism furthermore preferably includes a short circuit clutch which can connect two of the rotational members of the planetary gear set to each other.

The short circuit clutch may be located between the input and the output or between the drive away module's rotational members connected to the input and the output, but it may be more advantageous under certain circumstances for the short circuit clutch to be located between the brake or the third rotational member connected to it on the one hand, and the input or output or the first or second rotational member of the drive away module on the other.

The short circuit clutch is preferably positioned in a wet space of the driving mechanism, for example in the transmission housing, and is preferably operated by means of a plunger which is located in the transmission housing, while a pivot bearing is located between the plunger and the short circuit clutch.

The rotational members are preferably formed by a sun gear, a planet gear support and an ring gear, where the brake is preferably connected to the sun gear. The planetary gear set is preferably a reduction gear set if it is braked.

For mounting the drive away module in a simple fashion, the input and output of this module are preferably connected via splined connections to the drive source and the input shaft of the transmission.

Between the output shaft of the transmission and the final drive is preferably located a final clutch by which the forward gear can be selected. This final drive preferably consists of two gear transmissions.

Between the variator and the output of the final drive is preferably located an additional transmission which forms the reverse transmission. Preferably, at least one of the gears of the final drive forms part of the additional transmission.

Between the output shaft of the transmission and the additional transmission is preferably located a reverse clutch by which the reverse gear can be selected.

The reverse clutch and the final drive are preferably operated by a single actuating body which can adopt three positions: reverse clutch closed, final drive closed and reverse clutch and final drive open. This reverse clutch and this final drive are preferably arranged as claw clutches and/or synchronizers.

In a highly advantageous embodiment of the driving mechanism the driving mechanism does not comprise a cooler. Thanks to the dry drive away module, there is no need of a large cooling flow and thus no cooler either (this may be a heat exchanger which may be either air-cooled or water-cooled (preferably coupled to the cooling circuit of the drive source)). Owing to the omission of a torque converter as a drive away system, this does not need a large oil flow either. Since a cooler and a torque converter are normally the dominant oil flow users, the oil pump may have a much smaller configuration. Since the drive away module comprises a dry brake which can dissipate its heat to the transmission housing, a proper cooling without oil is guaranteed.

By actuating the brake the vehicle is accelerated from a rest position. Preferably, after the brake has been actuated, the short-circuit clutch is actuated and the brake is opened for further acceleration of the vehicle. The latter action preferably takes place when the top gear in the variator is reached and it is desired to further reduce the r.p.m. of the combustion engine.

Preferably when a change over is made from brake to short-circuit clutch, the r.p.m. of the engine is lowered.

The change over from brake to short-circuit clutch preferably takes place without the CVT variator significantly changing transmission or at a transmission ratio of the variator reducing towards the output, or if the desired power drops below a preset limit value.

### BRIEF DESCRIPTION OF THE DRAWINGS

The invention will now be described in more detail below based on an example of embodiment of the driving mechanism according to the invention while reference is made to the appended drawing figures, in which:

FIG. 1 shows a lay-out of a driving mechanism equipped with the hydraulic system according to the invention;

FIG. 2 shows a schematic diagram of the driving mechanism shown in FIG. 1;

FIG. 3 shows the hydraulic system of the driving mechanism shown in FIGS. 1 and 2;

FIG. 4 shows the basic part of the hydraulic system having the switchable valve at an alternative location;

FIG. 5 shows a part of an embodiment of the hydraulic system having two oil pumps;

FIG. 6 shows a part of an embodiment of the hydraulic system having a further additional valve between the output of the further oil pump and the oil tank;

FIG. 7 shows a part of a further embodiment of the hydraulic system having a further additional valve between the output of the further oil pump and the restriction;

FIG. 8 shows a part of yet a further embodiment of the hydraulic system having an auxiliary valve working in parallel with the switchable valve;

FIG. 9 shows a basic configuration of an embodiment of the hydraulic system according to the invention in a kiss point configuration; and

FIG. 10 shows a kiss point configuration applied to a conventional hydraulic system.

### DETAILED DESCRIPTION OF THE DRAWINGS

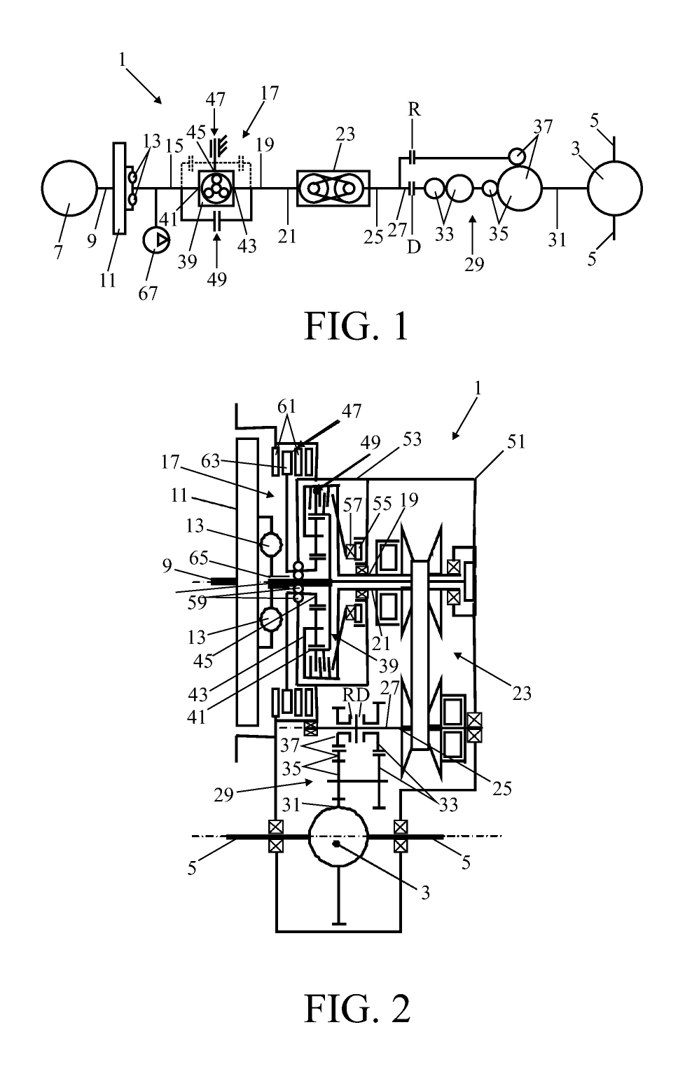

FIG. 1 shows a lay-out of a driving mechanism equipped with a hydraulic system according to the invention. The driving mechanism 1 is present in a vehicle of which only the differential 3 and the driving shafts 5 to the wheels are shown. The driving mechanism comprises a drive source 7 which in this embodiment is formed by a combustion engine, but which may, for example, also be formed by an electromotor. On the output shaft 9 of the drive source is located a flywheel 11 which is connected via torque dampers 13 to the input 15 of a drive away module 17. The output 19 of the drive away module is connected to the input shaft 21 of a transmission that forms part of the driving mechanism. In this embodiment this transmission is formed by a CVT variator 23 of which the output shaft 25 is connected to the input 27 of a final drive 29 that forms part of the driving mechanism. The output 31 of the final drive is connected to the differential 3 of the vehicle. This final drive 29 is formed by two gear transmissions 33 and 35.

Between the variator 23 and the output 31 of the final drive is located an additional transmission 37 that forms the reverse transmission. One of the gears 35 of the final drive forms part of this additional transmission 37.

Between the output shaft 25 of the transmission and the final drive 29 is located a final clutch D and between the output shaft 25 of the transmission and the additional transmission 37 is located a reverse clutch R. By means of these two clutches a choice can be made between driving forward and reversing. Both clutches D and R are arranged as claw clutches and/or synchronizers and are operated by a single actuation body which can adopt three positions: reversing clutch R closed, final clutch D closed and both clutches open.

The drive away module 17 is formed by a planetary gear set 39 comprising three rotational members, of which a first rotational member 41 is connected to the input 15, a second rotational member 43 is connected to the output 19 and a third rotational member 45 is connected to a brake 47. The directions of rotation of the input 15 and output 19 of the drive away module 17 are equal to each other.

Between the first and second rotational members 41 and 43 of the planetary gear set is located a short circuit clutch 49 by which these two rotational members can be connected to each other. It is alternatively possible for the short circuit clutch to be located between the third rotational member on the one hand and the first or second rotational member on the other, which is indicated by broken lines.

FIG. 2 shows a schematic diagram of the driving mechanism 1. The variator 23, final drive 29 with additional transmission 37 and the differential 3 are located in the transmission housing 51. To this transmission housing is fitted a housing part 53 in which the planetary gear set 39 of the drive away module and the short circuit clutch 49 are located. The space in the transmission housing 51 and the space between the housing part 53 and the transmission housing 51 are wet spaces. This short circuit clutch 49 is formed by a compound wet plate clutch and is operated via a plunger 55 which is located in the transmission housing 51. Between the plunger 55 and the short circuit clutch 49 is located a pivot bearing 57.

The brake 47 is a dry plate friction brake and is located in a dry space between the flywheel 11 and the housing part 53. Sealing rings 59 are fitted between the dry and wet spaces. The brake 47 comprises two brake plates 61 and a brake disc 63 installed in between which is covered with friction material. The brake plates 61 are connected to the transmission housing 51 and are actively cooled with cooling liquid from the drive source or with oil from the transmission. The brake plate 63 is connected to the third rotational member 45 of the planetary gear set which is formed by the sun gear of the planetary gear set. The ring gear 41 of the planetary gear set is connected to the input 15 and the planet gear support 43 is connected to the output 19 of the drive away module. The planetary gear set 39 is a speed reduction if the brake 47 is closed.

The input and output 15 and 19 respectively of the drive away module 17 are connected via splined connections 65 to the drive source 7 and the input shaft 21 of the transmission.

The driving mechanism comprises a hydraulic system for operating the brake and clutches and the variator. The hydraulic system 1 comprises an oil pump 67, see FIG. 1, which is connected to the input 15 of the drive away module 17.

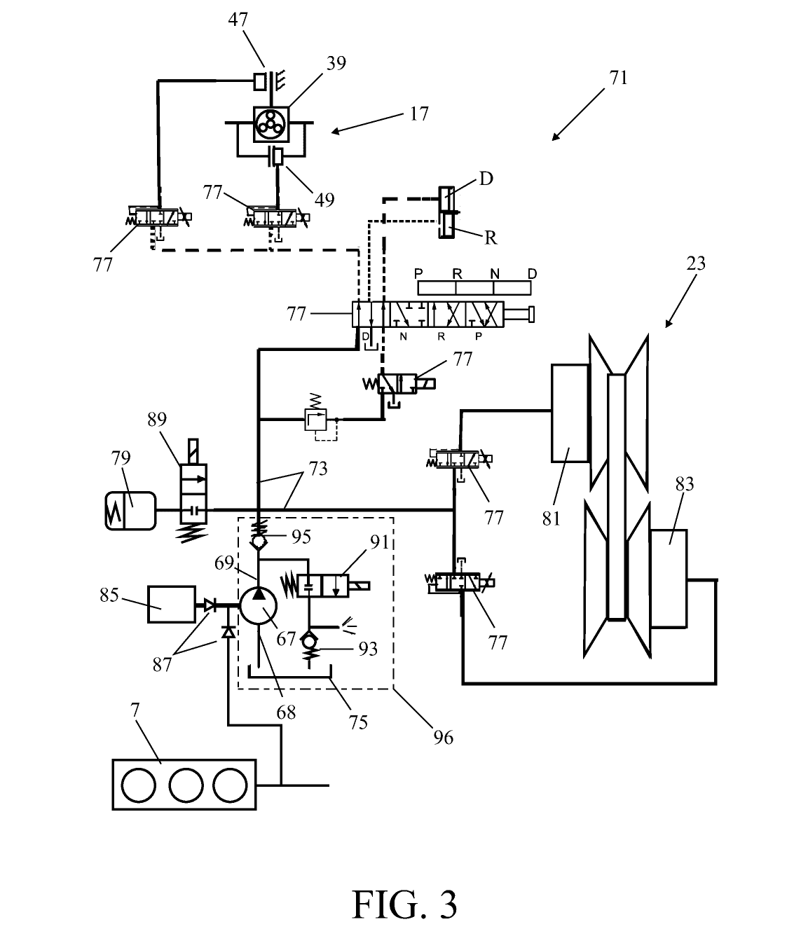

FIG. 3 shows the hydraulic system 71 of the driving mechanism. The hydraulic system comprises a main line 73 connected to the oil pump 67, which main line has a line pressure that is maintained by the oil pump. The oil pump 67 is connected with its input 68 to an oil tank 75. The hydraulic system 71 further includes a plurality of control valves 77 for operating the hydraulically controlled parts, inter alia, the brake 47, the CVT variator 23, the final clutch D, the reverse clutch R and the short circuit clutch 49, as well as an accumulator 79 which is connected to the main line 73. The control valves 77 can control the pressure on the primary pulley 81 and the pressure on the secondary pulley 83 of the variator 23 independently of each other.

The oil pump 67 is connected to an electromotor 85 and to the drive source 7 and can be driven by each one of these driving mechanisms. Between the drive source 7 and the oil pump 67 and between the electromotor 85 and the oil pump 67 are located freewheel bearing clutches 87. The electromotor 85 can intermittently drive the oil pump 67 to keep the accumulator 79 at the right pressure. Between the oil pump 67 and the accumulator 79 is located an on/off valve 89 and between the output 69 of the oil pump 67 and the oil tank 75 is located a further on/off valve 91 by means of which the line pressure produced by the oil pump can be reduced intermittently. Between the output 69 of the oil pump 67 and the oil tank 75 is located a pressure relief valve 93 and between the oil pump 67 and the main line 73 is located a non-return valve 95.

The on/off valve 89 between the hydraulic accumulator and the main line is closed when the drive source 7 stalls, and when increased line pressure is desired, the further on/off valve 91 is closed to increase the line pressure. When a very fast increase of the line pressure is desired, the further on/off valve 91 is closed to increase the oil pump pressure, and simultaneously or shortly after this, the on/off valve 89 between the hydraulic accumulator and the main line is closed.

The boxed part 96 in FIG. 3 constitutes the basic configuration of the hydraulic system according to the invention, in which the oil pump 67, by means of the switching of the switchable valve 91, can operate at high pressure or low pressure to feed the high pressure circuit, which in FIG. 3 is located downstream of (over) the further valve 95 (typically clutches, variator pulleys), and/or the low pressure circuit, which is connected to the branch line between the valve 91 and the restriction 93 (typically cooling, lubrication). The basic configuration 96 is intended to separate the low pressure circuit which typically requires a relatively high flow from the high pressure circuit so as to minimize the driving power of the oil pump 67 in this manner. The energetic advantages of this concept are greatest when the high pressure circuit asks for a low flow on average. In that case oil pump 67 can also be used if so desired for occasionally supplying extra flow to the high pressure circuit without the mean driving power of the oil pump 67 being increased significantly, while the high pressure circuit can be coupled to a 2^{nd} power supply which has a low flow on average. This 2^{nd} power supply may be arranged as accumulator 79 (see FIG. 3) which is intermittently loaded by the oil pump 67, or as a further pump 99 (see FIG. 5) which power supply at any rate delivers the leakage flow and in the case of the accumulator also the switching flows (pre-filling of plungers and subsequently building up pressure).

The basic configuration can thus be combined with an accumulator circuit which retains the high pressure and is intermittently loaded by the oil pump 67; the accumulator (either with a stop valve or not, more specifically for Start—Stop) can then also deliver peak flows (see FIG. 3).

The basic configuration may alternatively be extended with a further oil pump 99 (see FIG. 5) which retains the high pressure with a minimal pump capacity (for example to compensate for leakage). Peak flows are delivered by operating the oil pump 67 at high pressure (closing valve 91) so that the pressure relief valve 95 opens automatically. By following this procedure the further oil pump 99 may have a much smaller configuration than oil pump 67, which offers advantages as regards costs and delivery.

Both oil pumps can be driven by the same shaft or even be combined to a single double acting pump (for example a multiport vane pump); the further oil pump is then a second pump half of the double action pump. The two pump halves of the double action pump may be considerably asymmetrical.

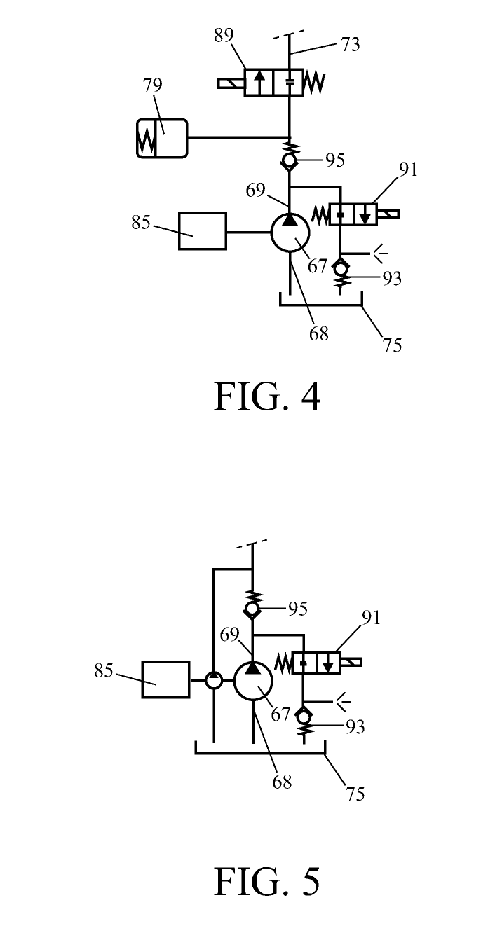

If the buffer is used for Start-Stop (S/S), a kiss point strategy may be followed or a peak flow strategy, each having its own hydraulic embodiment. The accumulator configurations in FIGS. 3 and 4 are intended for the peak flow strategy while the accumulator, during standstill of the combustion engine and the vehicle, is kept at the right pressure by means of the further switchable valve, in order to deliver a peak flow when subsequently the combustion engine is restarted so as to close the clutches as fast as possible. If the r.p.m. of the combustion engine is sufficiently high, the mechanically driven oil pump can again take over the pressure supply so that not a large accumulator is necessary either. The advantage of such strategy is the minimum leakage and the long stand-by time related to this.

The kiss point strategy is generally used in known applications with an electrically driven oil pump which keeps the clutch(es) pre-filled during S/S without significantly transferring torque. The advantage of this is that no peak flow need be delivered and undesired dynamic effects owing to step-sized pressures etc. are minimized. However, a disadvantage of this is that during S/S a power—low, admittedly—is continuously desired. Besides, an electric oil pump is relatively expensive and inefficient as a result of the various energy conversions, and its lifetime and robustness strongly depend on for example thermal load.

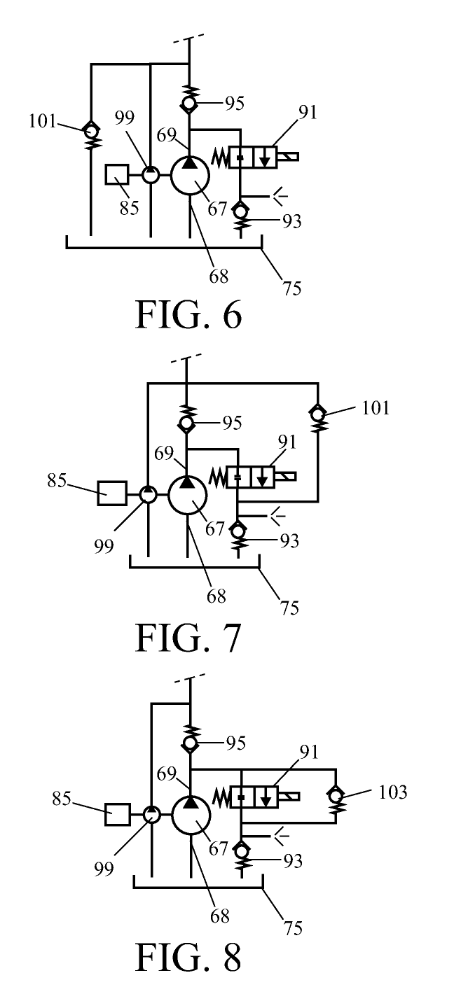

In FIG. 6 shows the hydraulic system part shown in FIG. 5 completed with a further additional valve 101 located between the output of the further oil pump 67 and the oil tank. FIG. 7 shows this part with the further additional valve 101 located between the output of the further oil pump 99 and the restriction 93.

FIG. 8 shows the hydraulic system part shown in FIG. 5 completed with an auxiliary valve 103 connected in parallel with the switchable valve 91.

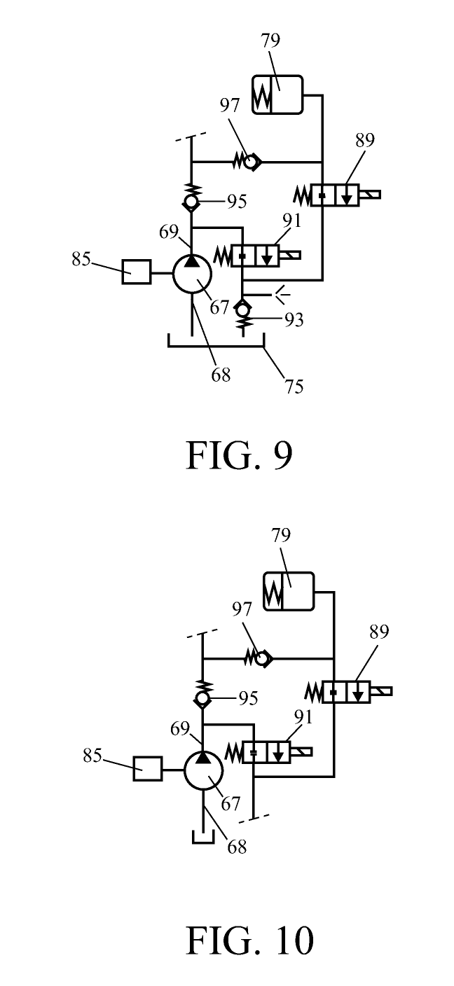

The configuration shown in FIG. 9 shows the accumulator concept combined with the kiss point strategy. In this configuration the accumulator 79 is loaded with the low pressure (cooling, lubrication), for which purpose the further switchable valve 89 is opened. Before the oil pump 67 stalls, the further switchable valve is closed so that the accumulator retains its pressure level. The non-return valve 99 opens automatically once the high pressure drops below x bars (for example 1 bar, which is determined by a spring).

In this way the users continue to be pre-filled at the high line pressure or kept at kiss point while the leakage (proportionally with pressure) can be kept low so that a small accumulator does have sufficient stand-by time. This kiss point strategy can also be applied to the lockup clutch of a torque converter, having the advantage that torque build-up through this clutch can be much faster than through the torque converter which first needs to have a considerable impeller speed (of the order of the stationary r.p.m.).

The basic configuration shown in FIG. 9 may in its turn be extended with a further oil pump or high pressure accumulator. Besides, the kiss point concept may also be applied to conventional actuation concepts with a single oil pump, see for example FIG. 10. In this figure there is also mention of a high pressure and a low pressure, while there is no further showing of how these lines are connected to the users in the system. The accumulator is connected via the further switchable valve 89 to a low pressure in the system (typically 2-6 bars) and via the non-return valve 97 to the high pressure side (typically 15-50 bars). A non-return valve 95 is inserted between the oil pump 67 and the high pressure line so as to avoid leakage via the oil pump when the oil pump is at idle.

Albeit the invention has been described in the foregoing based on the drawings, it should be observed that the invention is not by any manner or means restricted to the embodiment shown in the drawings. The invention also extends to all embodiments deviating from the embodiment shown in the drawings within the spirit and scope defined by the claims. The hydraulic system embodiments described above are not only applicable to the described driving mechanism having a continuously variable transmission, but also to other transmissions such as a double clutch transmission.

1. A hydraulic system for the actuation of a transmission system having shafts and a drive source, the hydraulic system comprising:
an oil pump, which is driven by one of the shafts of the transmission system or the drive source, which oil pump has an input and an output, which input is connected to an oil tank and which output is connected to a main line,
a switchable valve, which is located between the output of the oil pump and the oil tank,
a restriction, which is located between the switchable valve and the oil tank, and
a further valve, which is located between the output of the oil pump and the main line,
wherein the switchable valve is operated such that the line pressure produced by the oil pump can be made lower or higher than the pressure in the main line.

2. The hydraulic system of claim 1, wherein the switchable valve is arranged as an on/off valve.

3. The hydraulic system of claim 1, wherein the restriction is arranged as a valve.

4. The hydraulic system of claim 1, wherein the restriction is arranged as a pressure relief valve.

5. The hydraulic system of claim 1, wherein the further valve is arranged as a non-return valve.

6. The hydraulic system of claim 1, wherein the hydraulic system further includes an accumulator which is connected to the main line, where the switchable valve is operated such that the pressure in the accumulator is maintained between a minimum and a maximum value.

7. The hydraulic system of claim 6, wherein the hydraulic system further includes a further switchable valve which is located between the oil pump and the accumulator.

8. The hydraulic system of claim 6, wherein the hydraulic system further includes a further switchable valve which is located between the oil pump and the main line, where the accumulator is located between the further switchable valve and the output of the oil pump.

9. The hydraulic system of claim 6, wherein the hydraulic system further includes a further switchable valve which is located between the accumulator and the output of the switchable valve or the input of the restriction.

10. The hydraulic system of claim 7, wherein the further switchable valve is arranged as an on/off valve.

11. The hydraulic system of claim 1, wherein the hydraulic system further includes an additional valve which is located between the accumulator and the main line.

12. The hydraulic system of claim 11, wherein the additional valve is arranged as a non-return valve.

13. The hydraulic system of claim 1, wherein the hydraulic system further includes a further oil pump which is driven by one of the shafts of the transmission system or a drive source and has an input and an output, which input is connected to the oil tank (75) and which output is connected to the output of the further valve (95).

14. The hydraulic system of claim 13, wherein the further oil pump has a pump delivery that is less than one third of the delivery of the oil pump.

15. The hydraulic system of claim 13, wherein the further oil pump and the oil pump are both driven by the same shaft.

16. The hydraulic system of claim 13, wherein the further oil pump and the oil pump are combined to a single double acting oil pump which has one input and two outputs.

17. (canceled)

18. The hydraulic system of claim 13, wherein the hydraulic system further includes a further additional valve which is located between the output of the further oil pump and the oil tank.

19. (canceled)

20. (canceled)

21. (canceled)

22. The hydraulic system of claim 1, wherein the hydraulic system further includes an auxiliary valve which is located next to the switchable valve between the output of the oil pump and the pressure relief valve or which is integrated with the switchable valve.

23. (canceled)
